(19) United States
(12) Patent Application Publication
(10) Pub. No.: US 2010/0275069 A1
(43) Pub. Date: Oct. 28, 2010

(54) METHOD AND DEVICE FOR ACQUIRING MEDIA STREAM INFORMATION

(76) Inventor: Yangbo Lin, Shenzhen (CN)

Correspondence Address: Huawei/BHGL, P.O. Box 10395, Chicago, IL, 60610, US

(21) Appl. No.: 12/825,081

(22) Filed: Jun. 28, 2010

Related U.S. Application Data
(63) Continuation of application No. PCT/CN2008/073664, filed on Dec. 23, 2008.

(30) Foreign Application Priority Data
Dec. 28, 2007 (CN) 200710305683.1

(51) Int. Cl. G06F 15/16; G06F 11/07

(52) U.S. Cl. 714/48; 709/231; 714/E11.025

(57) ABSTRACT

A method and a device for acquiring media stream information are provided. The method includes the following steps. A media gateway controller (MGC) sends to a media gateway (MG) a command request for acquiring media stream information, where the command request carries property parameters corresponding to the desired media stream information. The MGC receives a corresponding command reply returned from the MG, and acquires the desired media stream information from the corresponding property parameters carried in the command reply. Therefore, the MGC is enabled to acquire from the MG the media stream information, and synchronization between media contents is realized.

### CROSS-REFERENCE TO RELATED APPLICATIONS

This application is a continuation of International Application No. PCT/CN2008/073664, filed on Dec. 23, 2008, which claims priority to Chinese Patent Application No. 200710305683.1, filed on Dec. 28, 2007, both of which are hereby incorporated by reference in their entireties.

### FIELD OF THE TECHNOLOGY

The present invention relates to the field of communications technologies, and more particularly to a method and a device for acquiring media stream information.

### BACKGROUND OF THE INVENTION

In the existing packet-based networks, Media Gateway Controller (MGC) and Media Gateway (MG) are two key components in a packet-based network with architecture in which services are separated from bearers. The MGC is responsible for service control and the MG is responsible for media bearing. Therefore, a service control plane and a media bearing plane are separated from each other. In this way, network resources can be better shared, device upgrading and service expansion can be simplified, and thus the development and maintenance costs can be reduced dramatically.

The MG and the MGC communicate with each other by using (media) gateway control protocols. The currently prevalent protocols include the H.248/Gateway Control Protocol (MeGaCo) and MGCP. The H.248/MeGaCo protocol is developed based on the MGCP. MGCP version 1 was set down by the Internet Engineering Task Force (IETF) in October, 1999 and was amended in January, 2003. H.248/MeGaCo version 1 was set down by the IETF and the International Telecommunications Union (ITU) together in November, 2000 and was amended in June, 2003. H.248 version 2 was set down by the ITU in May, 2002 and was amended in March, 2004. H.248 version 3 was set down by the ITU in September, 2005.

Under H.248, for example, there are the following abstract connection models. Various resources on the MG are abstracted as terminations. The terminations are categorized into physical terminations and ephemeral terminations. Physical terminations represent physical entities having a semi-permanent existence, such as a time division multiplex (TDM) timeslot, and ephemeral terminations represent public resources that are applied for temporarily and released after use, such as a Real-time Transport Protocol (RTP) stream. Further, a special termination called root termination represents the entire MG The association between terminations is abstracted as a context. The context may represent the association between multiple terminations, and a topology is used to describe the association between terminations. There is a special context called the null context, which contains terminations that are not associated with any other termination.

Based on the abstract connection models described above, the interaction between services and bearers is actually operations on terminations and contexts, and such operations are implemented by command requests and command replies between the MGC and the MG The types of commands include Add, Modify, Subtract, Move, AuditValue, AuditCapabilities, Notify, and ServiceChange. A command includes one or more command parameters, a command parameter is also called a descriptor , and the descriptor can be classified into Property, Signal, Event, and Statistic. For the sake of convenience, the parameters having service correlations are logically aggregated into a package.

The control over the MG, exercised by the MGC, may be pertinent to a termination or a stream on the termination. Non-stream-specific properties on the termination are represented by TerminationState descriptors, such as ServiceState and EventBufferControl. Stream-specific properties on the termination are represented by Media descriptors, which include a series of Stream descriptors, and each of the Stream descriptors is further classified into a LocalControl descriptor, a Local descriptor, and a Remote descriptor for a single stream. Specifically, the LocalControl descriptor represents stream-related control information, for example, Mode, ReserveGroup, and ReserveValue. The Local descriptor and the Remote descriptor represent properties of streams received locally and remotely respectively, such as addresses, ports, and codec algorithms, and the two descriptors may be in an SDP form.

In the prior art, when media are transmitted from a media provider to a user, the user needs to perform synchronization between media contents by using some information about the media, for example, to perform the synchronization between videos and audios. When RTP is adopted as a transport protocol for media stream transmission, the above information includes Synchronization Source (SSRC), Sequence Number, and Timestamp. The Synchronization Source represents the synchronization source used by the Sequence Number and Timestamp, the Sequence Number represents a first packet of media streams generated according to a media request, and the Timestamp represents an RTP timestamp corresponding to a start point of the media streams.

In the existing architecture with the MGC separated from the MG, the media streams are transmitted on the MG, and the user acquires from the MGC the information about the media streams. Therefore, in order to enable the user to realize synchronization between media contents through the above information, a support mechanism is required for the MGC to acquire information from the MG. However, such a support mechanism is not provided in the prior art.

### SUMMARY OF THE INVENTION

The present invention is directed to a method and a device for acquiring media stream information, so as to enable an MGC to acquire media stream information from an MG.

Accordingly, the present invention provides the following technical solutions.

A method for acquiring media stream information is provided. The method includes the following steps.

An MGC sends to an MG a command request for acquiring media stream information, where the command request carries property parameters corresponding to the desired media stream information.

The MGC receives a command reply returned from the MG, and acquires the desired media stream information from the property parameters carried in the command reply.

An MGC for acquiring media stream information is further provided. The MGC includes a command request sending unit and a command reply receiving unit.

The command request sending unit is configured to send to an MG a command request for acquiring media stream information, where the command request carries property parameters corresponding to the desired media stream information.

The command reply receiving unit is configured to receive a command reply returned from the MG, and acquire the desired media stream information from values of the property parameters carried in the command reply.

An MG for acquiring media stream information is further provided. The MG includes a command request receiving unit, a media stream information acquiring unit, and a command reply sending unit.

The command request receiving unit is configured to receive a command request, sent by an MGC, for acquiring media stream information, where the command request carries property parameters corresponding to the desired media stream information.

The media stream information acquiring unit is configured to acquire the desired media stream information according to the property parameters carried in the command request received by the command request receiving unit.

The command reply sending unit is configured to return a command reply to the MGC, where values of the property parameters carried in the command reply are the media stream information acquired by the media stream information acquiring unit.

In view of the above, in the embodiments of the present invention, by extending (media) gateway control protocols that include at least H.248 and MGCP, the MGC is enabled to send a command request to the MG through extended property parameters, so as to request the MG for the media stream information. The MG returns the media stream information to the MGC through a command reply. Therefore, the MGC is enabled to acquire from the MG the media stream information, and synchronization between media contents is realized.

### BRIEF DESCRIPTION OF THE DRAWINGS

FIG. 1 is a flow chart of a method for acquiring media stream information according to an embodiment of the present invention;

FIG. 2 is a flow chart of a method for acquiring media stream information according to Embodiment 1 of the present invention; and

FIG. 3 is a flow chart of a method for acquiring media stream information according to Embodiment 2 of the present invention.

### DETAILED DESCRIPTION OF THE EMBODIMENTS

In the embodiments of the present invention, by extending (media) gateway control protocols including, but not limited to, H.248 and MGCP, between an MG and an MGC, a simple and efficient solution is provided for the MGC to acquire from the MG the media stream information. The solution is described in detail below.

In the (media) gateway control protocols, the Synchronization Source, the Sequence Number, and the Timestamp are represented by a property command parameter respectively. These properties may be defined in an existing package or a new package, for example, the above properties are defined in a new package named “RTP Information (rtpinfo)”, where the property corresponding to the Synchronization Source is named “Synchronization Source (ssrc)” property and is used in the form of “rtpinfo/ssrc”; the property corresponding to the Sequence Number is named “Sequence Number (sn)” property and is used in the form of “rtpinfo/sn”; and the property corresponding to the Timestamp is named “Timestamp (ts)” property and is used in the form of “rtpinfo/ts”.

Specifically, the type of the ssrc property is string, and its value range may be set with a maximum length of 32 bits, for example, “rtpinfo/ssrc=ABC999” indicates that an identifier of the synchronization source to be selected (randomly) is ABC999. The type of the sn property is Integer, and its value range may be set to 0˜65535, for example, “rtpinfo/sn=666” indicates that the sequence number of the first packet of the synchronization source is 666. The type of the ts property is string, which may be composed of date and time, for example, “rtpinfo/ts=20080910T181716” indicates that the RTP timestamp of the start point of the synchronization source is 2008-09-10 18:17:16. Definitely, the ssrc property, the sn property, and the ts property as described above may also adopt other types, and their value ranges and compositions may be set, as actually requires, without affecting the implementation of the embodiments of the present invention.

It should be noted that, all of the above properties are used in a LocalControl descriptor, indicating that these properties are all directed to the stream on the termination. Furthermore, the above properties may be set as read only, so that the MGC can only read without modifying these properties after being set by the MG.

The specific implementation of the embodiments of the present invention is described in detail below with reference to the accompanying drawings. In the embodiments below, RTP information is taken as an example of the media stream information for illustration, and in other embodiments of the present invention, other types of media stream information may also be adopted for implementation.

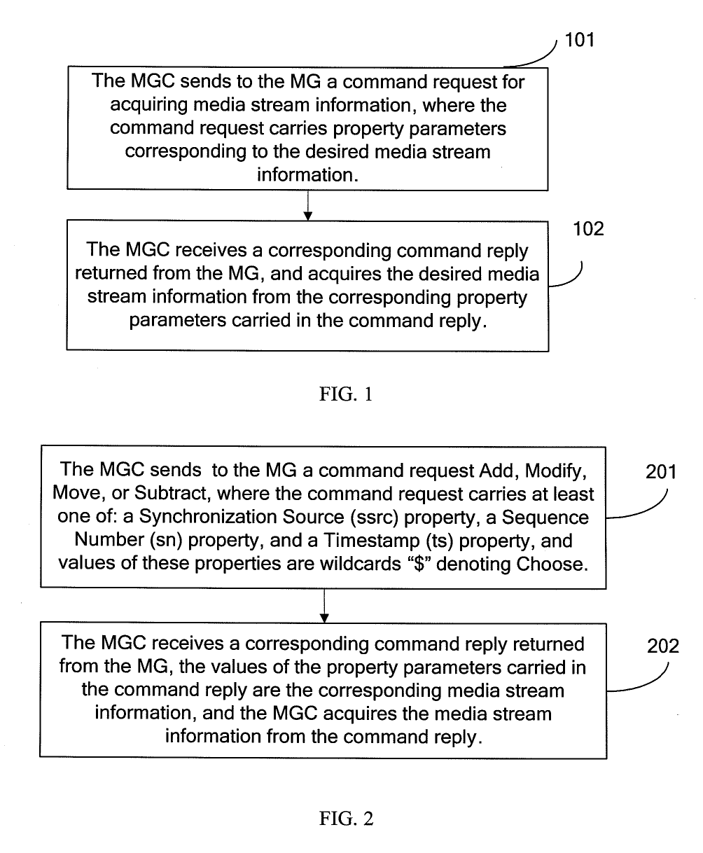

Referring to FIG. 1, the method for acquiring media stream information in an embodiment of the present invention includes the following steps.

In step 101, an MGC sends to an MG a command request for acquiring media stream information, where the command request carries property parameters corresponding to the desired media stream information.

In step 102, the MGC receives a command reply returned from the MG, and acquires the desired media stream information from the property parameters carried in the command reply.

In actual applications, the MGC may acquire the media stream information by using different types of commands. The specific implementation of the above method is illustrated in detail below through two examples.

### Embodiment 1

In Embodiment 1, the media stream information is acquired by using a command of Add, Modify, Move, or Subtract. Referring to FIG. 2, in this embodiment, the media stream information is acquired in the following steps.

In step 201, an MGC sends a command request Add, Modify, Move, or Subtract to an MG. The command request carries any one or any combination of the ssrc property, the sn property, and the ts property, and values of these properties are wildcards “$” representing Choose, indicating that the MGC intends to obtain from the MG the values of the properties carried in the command request.

In step 201, the properties carried in the command request are determined according to actual demands of acquiring the media stream information. For example, if it is required to obtain the synchronization source information in the media stream information, the command request may only include the ssrc property, and correspondingly, if it is required to obtain the sequence number information and/or the timestamp information in the media stream information, the command request needs to carry the sn property and/or the ts property. Therefore, the property included in the command request is corresponding to the desired media stream information.

In step 202, the MGC receives a corresponding command reply returned from the MG, the values of the property parameters carried in the command reply are the corresponding media stream information, and the MGC acquires the media stream information from the command reply.

In actual applications, if the information acquired by the MG (for example, through a Remote descriptor) is insufficient to meet the demand for the MGC to acquire the media stream information, the MG returns corresponding error indication information to the MGC and notifies the MGC that the MG cannot provide the corresponding media stream information. For example, when the MG cannot provide the desired media stream information for the MGC, the MG returns error information to the MGC. The error information is an error code 473, indicating that the desired information is unavailable.

Further, the above properties may be carried in the LocalControl descriptor for the stream and then sent.

A specific example is given below for illustrating the implementation of the above method.

The MGC delivers a command request Modify to the MG, and requests the MG to add one stream for a certain termination, in which rtpinfo/ssrc=$, rtpinfo/sn=$, and rtpinfo/ts=$ are carried in the LocalControl descriptor for the stream, indicating that the MGC requires the MG to notify the MGC of the synchronization source, the packet sequence number, and the RTP timestamp of the stream after adding the stream. The MG returns a corresponding command reply to the MGC, in which rtpinfo/ssrc=ABC999, rtpinfo/sn=666, and rtpinfo/ts=20080910T181716 are carried in the LocalControl descriptor for the stream, so as to notify the MGC of the corresponding media stream information of the newly added stream.

It should be noted that, when the MGC needs to acquire the media stream information for some specific media resources on the termination or the stream, the MGC also needs to carry identifier information indicating the media resources in the command request, so that the MG provides the media stream information associated with the media resources for the MGC according to the identifier information.

### Embodiment 2

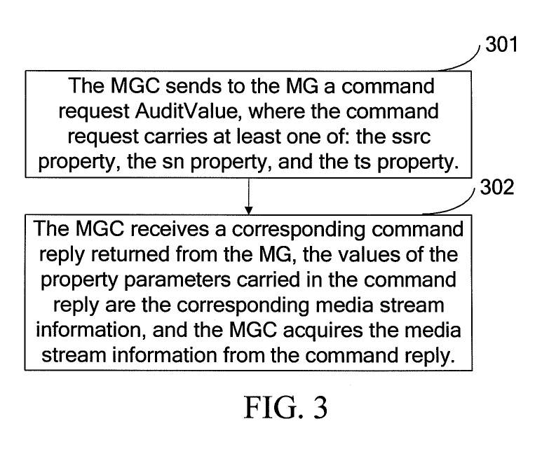

In Embodiment 2, the media stream information is acquired by using a command of AuditValue. Referring to FIG. 3, in this embodiment, the media stream information is acquired in the following steps.

In step 301, an MGC sends a command request AuditValue to an MG. The command request carries any one or any combination of the ssrc property, the sn property, and the ts property, indicating that the MGC intends to audit, from the MG, values of these properties carried in the command request.

Likewise, in step 301, the properties carried in the command request are determined according to actual demands of acquiring the media stream information.

In step 302, the MGC receives a corresponding command reply returned from the MG, the values of the property parameters carried in the command reply are the corresponding media stream information, and the MGC acquires the media stream information from the command reply.

Similar to Embodiment 1, if the information acquired by the MG (for example, through a Remote descriptor) is insufficient to meet the demand for the MGC to acquire the media stream information, the MG returns corresponding error indication information to the MGC and notifies the MGC that the MG cannot provide the corresponding media stream information. For example, when the MG cannot provide the desired media stream information for the MGC, the MG returns error information to the MGC. The error information is an error code 473, indicating that the desired information is unavailable.

Further, when the MGC needs to acquire the media stream information for some specific media resources on the termination or the stream, the MGC also needs to carry identifier information indicating the media resources in the command request, so that the MG provides to the MGC the media stream information associated with the corresponding media resources according to the identifier information.

In the above embodiments, before the MGC sends the command request for acquiring the media stream information to the MG, the method further includes the following step.

The MGC receives from a user a request for acquiring the media stream information.

Correspondingly, after the MGC receives the corresponding command reply returned from the MG, and acquires the desired media stream information from the corresponding property parameters carried in the command reply, the method further includes the following step.

The MGC sends the acquired media stream information to the user.

In this manner, the media stream information is provided for the user.

Corresponding to the method provided by the embodiments of the present invention, the present invention also provides an MGC for acquiring media stream information. The MGC includes a command request sending unit and a command reply receiving unit.

The command request sending unit is configured to send a command request to an MG for acquiring media stream information, where the command request carries property parameters corresponding to the desired media stream information.

The command reply receiving unit is configured to receive a command reply returned from the MG, and acquire the desired media stream information from values of the corresponding property parameters carried in the command reply.

Specifically, the command request sending unit may request to acquire the media stream information by sending a command request Add, Modify, Move, or Subtract to the MG. The command request carries any one or any combination of: the ssrc property, the sn property, and the ts property, and the values of the properties carried in the command request are wildcards “$” denoting Choose, indicating that the MGC intends to obtain from the MG the values of the properties carried in the command request. Correspondingly, the command reply receiving unit receives from the MG the command reply for Add, Modify, Move, or Subtract, and acquires the desired media stream information from the command reply.

The command request sending unit may also request to acquire the media stream information by sending a command request AuditValue to the MG. The command request AuditValue carries any one or any combination of the ssrc property, the sn property, and the ts property, indicating that the MGC intends to audit, from the MG, the values of the properties carried in the command request. Correspondingly, the command reply receiving unit receives from the MG the command reply for AuditValue, and acquires the desired media stream information from the command reply.

Corresponding to the method provided by the embodiments of the present invention, the present invention also provides an MG for acquiring media stream information. The MG includes a command request receiving unit, a media stream information acquiring unit, and a command reply sending unit.

The command request receiving unit is configured to receive a command request sent by an MGC for acquiring media stream information, where the command request carries property parameters corresponding to the desired media stream information.

The media stream information acquiring unit is configured to acquire the desired media stream information according to the property parameters carried in the command request received by the command request receiving unit.

The command reply sending unit is configured to return a command reply to the MGC, where values of the corresponding property parameters carried in the command reply are the media stream information acquired by the media stream information acquiring unit.

Specifically, the command request receiving unit may receive from the MGC a command request Add, Modify, Move, or Subtract, and correspondingly, the command reply sending unit returns the desired media stream information to the MGC by returning to the MGC a command reply for Add, Modify, Move, or Subtract.

The command request receiving unit may also receive from the MGC a command request AuditValue, and correspondingly, the command reply sending unit returns the desired media stream information to the MGC by returning to the MGC a command reply for AuditValue.

Corresponding to the method provided by the embodiments of the present invention, the present invention also provides a system for acquiring media stream information. The system includes an MGC and an MG.

The MGC is configured to send to the MG a command request for acquiring media stream information, where the command request carries property parameters corresponding to the desired media stream information, and is configured to receive a command reply returned from the MG and acquire the desired media stream information from values of the corresponding property parameters carried in the command reply.

The MG is configured to receive the command request sent by the MGC, and return to the MGC the corresponding media stream information as the values of the property parameters according to the property parameters in the command request.

It should be noted that the above descriptions are merely some exemplary embodiments of the present invention, and those skilled in the art may make various improvements and refinements without departing from the spirit of the invention. All such modifications and refinements are intended to be covered by the present invention.

What is claimed is:

1. A method for acquiring media stream information, comprising:
sending, by a media gateway controller (MGC), a command request, to a media gateway (MG), for acquiring media stream information, wherein the command request carries property parameter corresponding to the desired media stream information; and
receiving, by the MGC, a corresponding command reply returned from the MG, and acquiring the desired media stream information from the corresponding property parameter carried in the command reply.

2. The method according to claim 1, wherein the property parameters carried in the command request sent by the MGC and the command reply received by the MGC comprise at least one of:
a Synchronization Source property, a Sequence Number property, and a Timestamp property.

3. The method according to claim 2, wherein the sending, by the MGC, a command request, to the MG, for acquiring the media steam information comprises:
sending, by the MGC, a command request Add, Modify, Move, or Subtract to the MG, wherein values of the property is wildcard denoting Choose, indicating that the MGC intends to obtain from the MG the values of the property carried in the command request; and
the command reply returned by the MG comprises the property carried in the command request, and the values of the property are the media stream information.

4. The method according to claim 2, wherein the sending, by the MGC, the command request, to the MG, for acquiring the media steam information comprises:
sending, by the MGC, the command request AuditValue to the MG, wherein the command reply returned by the MG comprises the property carried in the command request, and the value of the property is the media stream information.

5. The method according to claim 1, wherein if the MG cannot provide the desired media stream information for the MGC, the method further comprises:
returning, by the MG, error indication information to the MGC.

6. The method according to claim 1, wherein media resource identifier information is further carried in the command request sent by the MGC to the MG; and
the command reply returned by the MG is generated after the MG acquires the media stream information associated with the media resources according to the media resource identifier information.

7. The method according to claim 1, wherein the property parameters are transmitted through a LocalControl descriptor for the stream.

8. The method according to claim 1, wherein
the property parameter is set to be read only, and before the sending, by the MGC, a command request, to the MG, for acquiring the media steam information, the method further comprises: receiving, by the MGC, a request, from a user, for acquiring the media stream information; and
after the receiving, by the MGC, the command reply returned from the MG, and acquiring the desired media stream information from the property parameters carried in the command reply, the method further comprises: sending, by the MGC, the acquired media stream information to the user.

9. A media gateway controller (MGC) for acquiring media stream information, comprising:
a command request sending unit, configured to send to a media gateway (MG) a command request for acquiring media stream information, wherein the command request carries property parameter corresponding to the desired media stream information; and
a command reply receiving unit, configured to receive a command reply returned from the MG, and acquire the desired media stream information from value of the property parameter carried in the command reply.

10. A media gateway (MG) for acquiring media stream information, comprising:
a command request receiving unit, configured to receive a command request, sent by a media gateway controller (MGC), for acquiring media stream information, wherein property parameter corresponding to the desired media stream information is carried in the command request;
a media stream information acquiring unit, configured to acquire the desired media stream information according to the property parameter carried in the command request received by the command request receiving unit; and
a command reply sending unit, configured to return a command reply to the MGC, wherein value of the property parameters carried in the command reply is the media stream information acquired by the media stream information acquiring unit.

11. A system for acquiring media stream information, comprising an MGC and an MG, wherein:
the MGC is configured to send to the MG a command request for acquiring media stream information, wherein the command request carries property parameter corresponding to the desired media stream information, and is configured to receive a command reply returned from the MG and acquire the desired media stream information from value of the corresponding property parameter carried in the command reply; and
the MG is configured to receive the command request sent by the MGC, and return to the MGC the corresponding media stream information as the value of the property parameter according to the property parameter in the command request.
